(19) United States
(12) Patent Application Publication
(10) Pub. No.: US 2017/0164387 A1
(43) Pub. Date: Jun. 8, 2017

(54) WIRELESS LOCAL AREA NETWORK (WLAN) UPLINK TRANSCEIVER SYSTEMS AND METHODS

(71) Applicant: InterDigital Patent Holdings, Inc., Wilmington, DE (US)

(72) Inventors: Hanqing Lou, Syosset, NY (US); Pengfei Xia, San Diego, CA (US); Monisha Ghosh, Chicago, IL (US); Juan Fang, Brooklyn, NY (US); Oghenekome Oteri, San Diego, CA (US); Nirav B. Shah, San Diego, CA (US); Robert L. Olesen, Huntington, NY (US)

(73) Assignee: InterDigital Patent Holdings, Inc., Wilmington, DE (US)

(21) Appl. No.: 15/325,887

(22) PCT Filed: Jul. 17, 2015
(86) PCT No.: PCT/US2015/040875

§ 371 Date: Jan. 12, 2017

Related U.S. Application Data
(60) Provisional application No. 62/026,329, filed on Jul. 18, 2014.

(51) Int. Cl. H04W 72/12; H04W 52/18; H04B 7/0452

(52) U.S. Cl. CPC H04W 72/1252; H04B 7/0452; H04W 52/18

(57) ABSTRACT

Systems, methods, and instrumentalities are described to implement WLAN uplink multi-user multiple input multiple output (UL MU-MIMO) communication in an Institute of Electrical and Electronics Engineers (IEEE) 802.11 based system, using an IEEE 802.11 station (STA). The STA may receive a downlink poll frame from an IEEE 802.11 access point (AP) including one or more of a request for reporting of a transmit power, a request for a timestamp of a response frame, or a request for an estimated carrier frequency offset (CFO) value. The STA may send an uplink response frame. The uplink response frame may include one or more of transmit power parameters, timestamp parameters, or an estimated CFO value to an AP. The STA may receive a schedule frame, wherein the schedule frame may include indication to adjust one or more of a transmit power, a timing correction value, or a CFO correction value.

### CROSS-REFERENCE TO RELATED APPLICATIONS

This application claims the benefit of the U.S. Provisional Application No. 62/026,329, filed Jul. 18, 2014, which is hereby incorporated by reference herein.

### BACKGROUND

Due to an increasing demand for wireless communication services and bandwidth capacities, wireless networks, for example wireless local area networks (WLANs) may use multiple-input multiple-output (MIMO) technologies, e.g., multi-user MIMO (MU-MIMO). One or more WLAN devices, e.g., WLAN stations (STAB), may be configured for MU-MIMO. Use of such configurations may offer significant increases in performance, e.g., data throughput efficient bandwidth use. However, performance of existing MU-MIMO technologies (e.g., bandwidth utilization of uplink MU-MIMO) may be inadequate.

### SUMMARY OF THE INVENTION

Systems, methods, and instrumentalities are described to implement WLAN uplink multi-user multiple input multiple output (UL MU-MIMO) communication, e.g., in an Institute of Electrical and Electronics Engineers (IEEE) 802.11 based system, using an IEEE 802.11 station (STA), for example. The STA may receive a downlink poll frame, e.g., from an IEEE 802.11 access point (AP), wherein the downlink poll frame may include one or more of a request for reporting of a transmit power, a request for a timestamp of a response frame, or a request for an estimated carrier frequency offset (CFO) value between the AP and the STA. The downlink poll frame may be received via a control frame, command frame, or a management frame.

The STA may send an uplink response frame. The uplink response frame may include one or more of transmit power parameter(s), timestamp parameter(s), or an estimated CFO value to an AP. The transmit power parameters may include one or more of a transmit power, a transmit antenna gain, a transmit power headroom, etc. The timestamp parameters may include the timestamp of a response frame at the STA. The uplink response frame may include an indication of whether the transmit power parameters are for the entire bandwidth or for one or more sub-channels. The uplink response frame may be sent via a control frame, command frame, or a management frame.

The STA may receive a schedule frame. The schedule frame may include an indication to adjust one or more of a transmit power, a timing correction value, or a CFO correction value. The transmit power may be adjusted over a bandwidth or a sub-channel. The STA may adjust transmit power of a transmit signal based on the received indication. The STA may apply one or more of the received timing correction value or the received CFO correction value to the transmit signal. The timing correction value and/or the CFO correction value may be a quantized timing correction value and/or a quantized CFO correction value. The STA may send the transmit signal.

The systems and methods of this invention may include an access point for associating with a wireless area network having a plurality of wireless stations that can each communicate with the access point via a single transmit opportunity that comprises a metric and a resolution. The access point may include a processor that is configured to determine, within the single transmit opportunity, a group of compatible stations based on the metrics and the resolutions for each of the plurality of wireless stations; and send, within the single transmit opportunity, a configuration to each of the plurality of wireless stations in the group of compatible stations based on the metrics and the resolutions. The configuration may include at least one of a respective power value or a respective frequency offset. The metric for each of the plurality of wireless stations may include one or more of a power value or a frequency offset. The resolution for each of the plurality of wireless stations may be associated with an uplink transmission from each of the plurality of wireless stations. The uplink transmission may be one of a multiple input-multiple output (MU-MIMO) transmission or an orthogonal frequency-division multiple access (OFDMA) transmission. The access point processor may be configured to determine at least one of a transmit power or a timing advance for the group of compatible stations based on the metrics and resolutions, to determine a transmit power adjustment for the group of compatible stations based on the metrics and resolutions, and/or determine a frequency correction for the group of compatible stations based on the metrics and resolutions.

### BRIEF DESCRIPTION OF THE DRAWINGS

A more detailed understanding may be had from the following description, given by way of example in conjunction with the accompanying drawings.

FIG. 1A illustrates an exemplary communications system.

FIG. 1B illustrates an exemplary wireless transmit/receive unit (WTRU).

FIG. 1C illustrates exemplary wireless local area network (WLAN) devices.

FIG. 2 illustrates an example of a block diagram of an UL Coordinated Orthogonal Block-based Resource Allocation (COBRA) transmitter.

FIG. 3 illustrates an exemplary one channel access mechanism that may be used for a group of STAs that have been scheduled and/or identified for multi-user communications.

FIG. 3A illustrates an example of an access point processing in a transmission opportunity (TXOP).

FIG. 3B illustrates an example of multi user synchronization in a single TXOP.

FIG. 4 illustrates an example of a COBRA schedule frame that may include a multi-user control field.

FIG. 5 illustrates an example of a CBORA schedule frame that may include a multi-user control field.

FIG. 6 illustrates an example of a receiver for reception of an uplink COBRA transmissions.

FIG. 7 illustrates an example of a receiver for reception of an uplink COBRA transmissions.

FIG. 8 illustrates an example of residual Carrier Frequency Offset (CFO) distribution functions.

FIG. 9 illustrates an example of simulation results of single data stream uplink COBRA transmission over Channel B.

FIG. 10 illustrates an example of simulation results of single data stream uplink COBRA transmission over Channel D.

### DETAILED DESCRIPTION

A detailed description of illustrative embodiments will now be described with reference to the various figures. Although this description provides a detailed example of possible implementations, it should be noted that the details are intended to be exemplary and in no way limit the scope of the application.

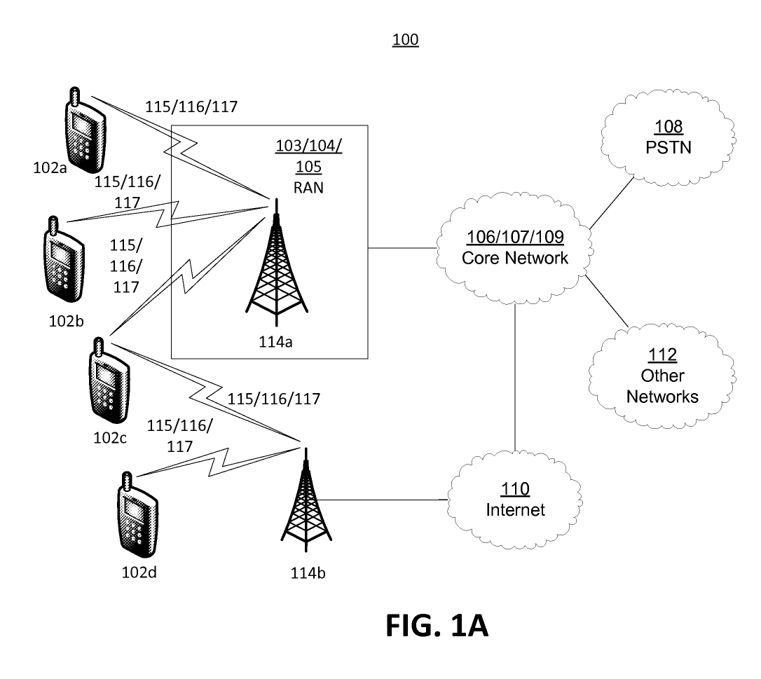

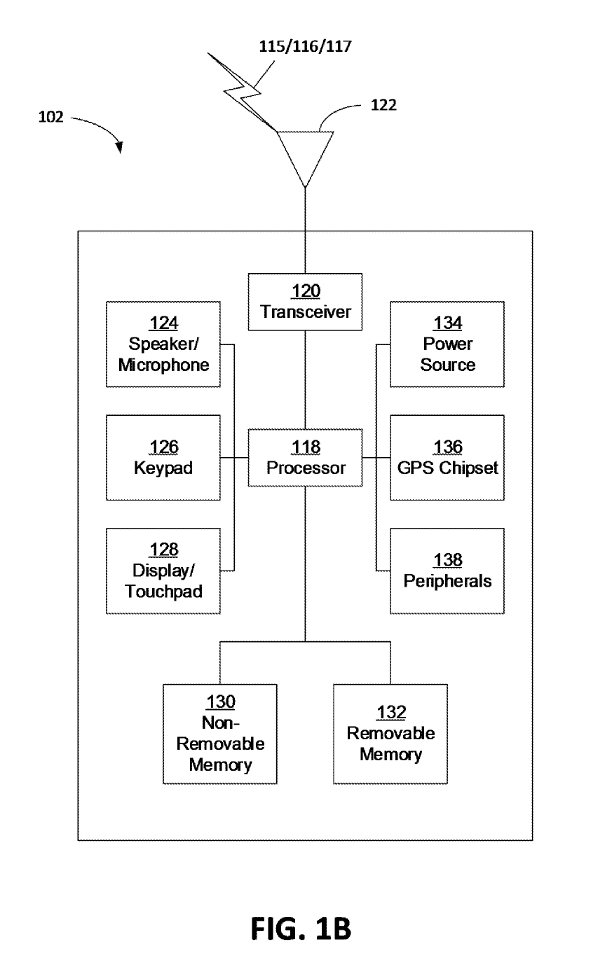

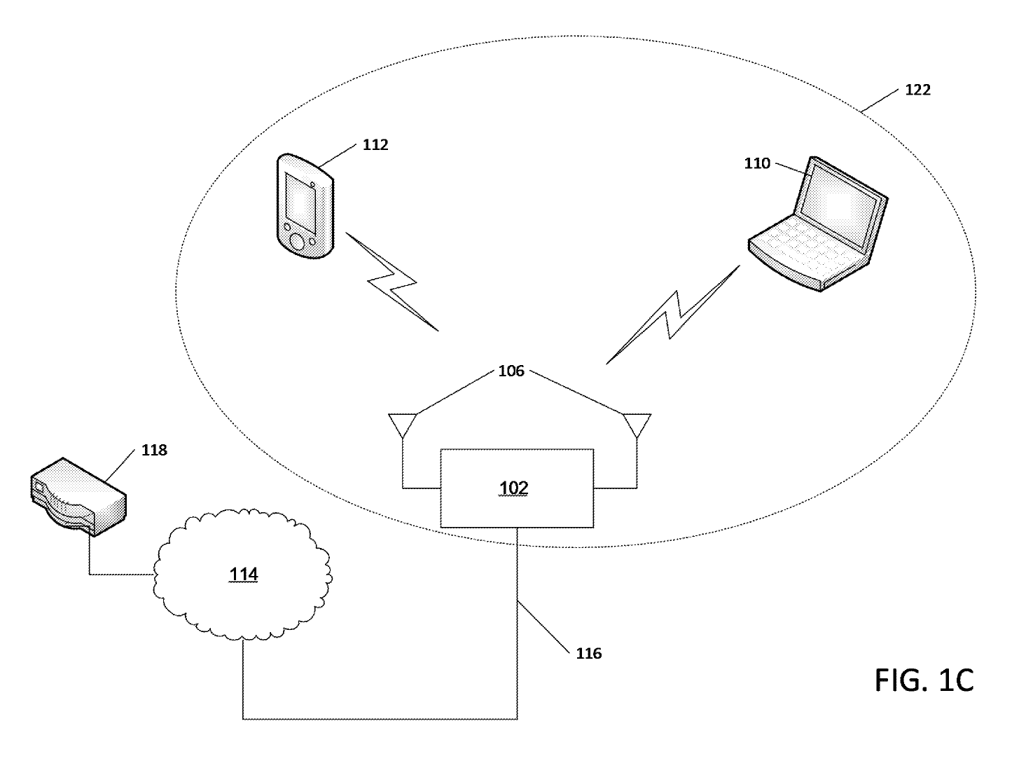

FIG. 1A is a diagram of an example communications system 100 in which one or more disclosed features may be implemented. For example, a wireless network (e.g., a wireless network comprising one or more components of the communications system 100) may be configured such that bearers that extend beyond the wireless network (e.g., beyond a walled garden associated with the wireless network) may be assigned QoS characteristics.

The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include at least one wireless transmit/receive unit (WTRU), such as a plurality of WTRUs, for instance WTRUs 102a, 102b, 102c, and 102d, a radio access network (RAN) 104, a core network 106, a public switched telephone network (PSTN) 108, the Internet 110, and other networks 112, though it should be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it should be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it should be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B depicts an exemplary wireless transmit/receive unit, WTRU 102. WTRU 102 may be used in one or more of the communications systems described herein. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It should be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it should be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It should be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It should be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C illustrates exemplary wireless local area network (WLAN) devices. One or more of the devices may be used to implement one or more of the features described herein. The WLAN may include, but is not limited to, access point (AP) 102, station (STA) 110, and STA 112. STA 110 and 112 may be associated with AP 102. The WLAN may be configured to implement one or more protocols of the IEEE 802.11 communication standard, which may include a channel access scheme, such as DSSS, OFDM, OFDMA, etc. A WLAN may operate in a mode, e.g., an infrastructure mode, an ad-hoc mode, etc.

A WLAN operating in an infrastructure mode may comprise one or more APs communicating with one or more associated STAs. An AP and STA(s) associated with the AP may comprise a basic service set (BSS). For example, AP 102, STA 110, and STA 112 may comprise BSS 122. An extended service set (ESS) may comprise one or more APs (with one or more BSSs) and STA(s) associated with the APs. An AP may have access to, and/or interface to, distribution system (DS) 116, which may be wired and/or wireless and may carry traffic to and/or from the AP. Traffic to a STA in the WLAN originating from outside the WLAN may be received at an AP in the WLAN, which may send the traffic to the STA in the WLAN. Traffic originating from a STA in the WLAN to a destination outside the WLAN, e.g., to server 118, may be sent to an AP in the WLAN, which may send the traffic to the destination, e.g., via DS 116 to network 114 to be sent to server 118. Traffic between STAs within the WLAN may be sent through one or more APs. For example, a source STA (e.g., STA 110) may have traffic intended for a destination STA (e.g., STA 112). STA 110 may send the traffic to AP 102, and, AP 102 may send the traffic to STA 112.

A WLAN may operate in an ad-hoc mode. The ad-hoc mode WLAN may be referred to as independent basic service set (IBBS). In an ad-hoc mode WLAN, the STAs may communicate directly with each other (e.g., STA 110 may communicate with STA 112 without such communication being routed through an AP).

IEEE 802.11 devices (e.g., IEEE 802.11 APs in a BSS) may use beacon frames to announce the existence of a WLAN network. An AP, such as AP 102, may transmit a beacon on a channel, e.g., a fixed channel, such as a primary channel. A STA may use a channel, such as the primary channel, to establish a connection with an AP.

STA(s) and/or AP(s) may use a Carrier Sense Multiple Access with Collision Avoidance (CSMA/CA) channel access mechanism. In CSMA/CA a STA and/or an AP may sense the primary channel. For example, if a STA has data to send, the STA may sense the primary channel. If the primary channel is detected to be busy, the STA may back off. For example, a WLAN or portion thereof may be configured so that one STA may transmit at a given time, e.g., in a given BSS. Channel access may include RTS and/or CTS signaling. For example, an exchange of a request to send (RTS) frame may be transmitted by a sending device and a clear to send (CTS) frame that may be sent by a receiving device. For example, if an AP has data to send to a STA, the AP may send an RTS frame to the STA. If the STA is ready to receive data, the STA may respond with a CTS frame. The CTS frame may include a time value that may alert other STAs to hold off from accessing the medium while the AP initiating the RTS may transmit its data. On receiving the CTS frame from the STA, the AP may send the data to the STA.

A device may reserve spectrum via a network allocation vector (NAV) field. For example, in an IEEE 802.11 frame, the NAV field may be used to reserve a channel for a time period. A STA that wants to transmit data may set the NAV to the time for which it may expect to use the channel. When a STA sets the NAV, the NAV may be set for an associated WLAN or subset thereof (e.g., a BSS). Other STAs may count down the NAV to zero. When the counter reaches a value of zero, the NAV functionality may indicate to the other STA that the channel is now available.

The devices in a WLAN, such as an AP or STA, may include one or more of the following: a processor, a memory, a radio receiver and/or transmitter (e.g., which may be combined in a transceiver), one or more antennas (e.g., antennas 106 in FIG. 1C), etc. A processor function may comprise one or more processors. For example, the processor may comprise one or more of: a general purpose processor, a special purpose processor (e.g., a baseband processor, a MAC processor, etc.), a digital signal processor (DSP), Application Specific Integrated Circuits (ASICs), Field Programmable Gate Array (FPGAs) circuits, any other type of integrated circuit (IC), a state machine, and the like. The one or more processors may be integrated or not integrated with each other. The processor (e.g., the one or more processors or a subset thereof) may be integrated with one or more other functions (e.g., other functions such as memory). The processor may perform signal coding, data processing, power control, input/output processing, modulation, demodulation, and/or any other functionality that may enable the device to operate in a wireless environment, such as the WLAN of FIG. 1C. The processor may be configured to execute processor executable code (e.g., instructions) including, for example, software and/or firmware instructions. For example, the processer may be configured to execute computer readable instructions included on one or more of the processor (e.g., a chipset that includes memory and a processor) or memory. Execution of the instructions may cause the device to perform one or more of the functions described herein.

A device may include one or more antennas. The device may employ multiple input multiple output (MIMO) techniques. The one or more antennas may receive a radio signal. The processor may receive the radio signal, e.g., via the one or more antennas. The one or more antennas may transmit a radio signal (e.g., based on a signal sent from the processor).

The device may have a memory that may include one or more devices for storing programming and/or data, such as processor executable code or instructions (e.g., software, firmware, etc.), electronic data, databases, or other digital information. The memory may include one or more memory units. One or more memory units may be integrated with one or more other functions (e.g., other functions included in the device, such as the processor). The memory may include a read-only memory (ROM) (e.g., erasable programmable read only memory (EPROM), electrically erasable programmable read only memory (EEPROM), etc.), random access memory (RAM), magnetic disk storage media, optical storage media, flash memory devices, and/or other non-transitory computer-readable media for storing information. The memory may be coupled to the processer. The processer may communicate with one or more entities of memory, e.g., via a system bus, directly, etc.

A WLAN in infrastructure basic service set (IBSS) mode may have an access point (AP) for the basic service set (BSS) and one or more stations (STAs) associated with the AP. The AP may have access or interface to a distribution system (DS) or another type of wired/wireless network that may carry traffic in and out of the BSS. Traffic to STAs may originate from outside the BSS, may arrive through the AP and may be delivered to the STAs. Traffic originating from STAs to destinations outside the BSS may be sent to the AP to be delivered to the respective destinations. Traffic between STAs within the BSS may be sent through the AP where the source STA may send traffic to the AP and the AP may deliver the traffic to the destination STA. Traffic between STAs within a BSS may be peer-to-peer traffic. Such peer-to-peer traffic may be sent directly between the source and destination STAs, e.g., with a direct link setup (DLS) using an IEEE 802.11e DLS or an IEEE 802.11z tunneled DLS (TDLS). A WLAN using an independent BSS (IBSS) mode may have no APs, and the STAs may communicate directly with each other. This mode of communication may be an ad-hoc mode.

Using the IEEE 802.11 infrastructure mode of operation, the AP may transmit a beacon on a fixed channel, e.g., the primary channel. This channel may be 20 MHz wide, and may be the operating channel of the BSS. This channel may also be used by the STAs to establish a connection with the AP. The channel access in an IEEE 802.11 system may be Carrier Sense Multiple Access with Collision Avoidance (CSMA/CA). In the infrastructure mode of operation, each STA may sense the primary channel. If a STA detects that the channel is busy, the STA may back off One STA may transmit at any given time in a given BSS.

In various countries around the world, dedicated spectrum may be allocated for wireless communication systems such as WLANs. The allocated spectrum (e.g., below 1 GHz) may be limited in the size and channel bandwidth. The spectrum may be fragmented. The available channels may not be adjacent and may not be combined for larger bandwidth transmissions. WLAN systems, for example built on the IEEE 802.11 standard, may be designed to operate in such spectrum. Given the limitations of such spectrum, the WLANs systems may be able to support smaller bandwidths and lower data rates compared to HT and/or VHT WLAN systems (e.g., based on the IEEE 802.11n and/or 802.11ac standards).

Spectrum allocation in one or more countries may be limited. For example, in China the 470-566 and 614-787 MHz bands may allow 1 MHz bandwidth. In addition to 1 MHz bandwidth, a 2 MHz with 1 MHz mode may be supported. The 802.11ah physical layer (PHY) may support 1, 2, 4, 8, and 16 MHz bandwidths.

A WLAN system, e.g., an IEEE 802.11ac may be used to improve spectral efficiency. For example an IEEE 802.11ac based system may use downlink Multi-User MIMO (MU-MIMO) transmission to multiple STA's in the same symbol's time frame, e.g. during a downlink OFDM symbol. Such downlink MU-MIMO may also be used in other WLAN systems, e.g., an IEEE 802.11ah system. The downlink MU-MIMO, e.g., as used in an IEEE 802.11ac system may use the same symbol timing to multiple STA's. Such an arrangement may be used to mitigate interference transmissions to multiple STA's. Each of the STA's involved in MU-MIMO transmission with the AP may use the same channel or band. Such a use of the same channel or band may limit the operating bandwidth to the smallest channel bandwidth that is supported by the STAs that are included in the MU-MIMO transmission with an AP.

In an IEEE 802.11ac base system, multiple channels may by combined to achieve higher bandwidths. For example up to eight contiguous 20 MHz channels, or two non-contiguous 80 MHz channels may be used to provide 160 MHz bandwidth. An IEEE 802.11ac transmission may assume use of the allocated bandwidth for transmission and/or reception. In a WLAN system, e.g., IEEE 802.11ax the performance, e.g., spectral efficiency, area throughput, robustness to collisions, interference management, etc. of an IEEE 802.11ac based system may be further enhanced. For example, an OFDMA transmission may be used. However a direct application of OFDMA to Wi-Fi may introduce backward compatibility issues. Therefore, Coordinated Orthogonal Block-based Resource Allocation (COBRA) with OFDMA may be used to mitigate Wi-Fi backward compatibility issues and the implicit inefficiencies that may be caused by channel based resource scheduling. For example, COBRA may enable transmissions over multiple smaller frequency-time resource units. Thus multiple users may be allocated to non-overlapping frequency-time resource unit(s), and may be enabled to transmit and receive simultaneously. A sub-channel may be defined as a basic frequency resource unit that an AP may allocate to a STA. For example, a sub-channel defined as a 20 MHz channel may be used for backward compatibility with 802.11n/ac based systems.

COBRA may include one or more of multicarrier modulation, filtering, time, frequency, space, and polarization domains as the basis for the transmission and coding scheme. For example, a COBRA scheme may use one or more of an OFDMA sub-channelization, an SC-FDMA sub-channelization, or a Filter-Bank Multicarrier sub-channelization.

To enable COBRA transmissions, one or more of the following may be provided: coverage range extension, grouping of users, channel access, preamble with low overhead, beamforming and sounding, frequency and timing synchronization, or link adaptation.

Timing and frequency synchronization for COBRA may be provided. Multi-user and single user multiple parallel (MU-PCA) channel access schemes may be provided. MU-PCA may provide Multi-user/Single-User parallel channel access using transmit/receive with symmetrical bandwidth and/or Multi-user/Single-User parallel channel access transmit/receive with asymmetrical bandwidth.

The Multi-user/Single-User parallel channel access using transmit/receive with symmetrical bandwidth may further provide one or more of Down-link parallel channel access for multiple/single users, Up-link parallel channel access for multiple/single users, combined Down-link and Up-link Parallel Channel Access for multiple/single users, or unequal MCS and unequal Transmit Power for SU-PCA and COBRA. The Multi-user/Single-User parallel channel access using transmit/receive with symmetrical bandwidth may further provide physical layer (“PHY”) design and/or mixed MAC/PHY Multi-User Parallel Channel Access

The Multi-user/Single-User parallel channel access transmit/receive with asymmetrical bandwidth may further provide MAC designs for downlink, uplink and combined uplink and downlink for multi-user/single-user parallel channel access using transmit/receive with asymmetrical bandwidth and/or PHY designs to support multi-user/single-user parallel channel access using transmit/receive with asymmetrical bandwidth.

Physical layer transmitter design may provide a single user transmission. In an example, the physical layer transmitter may also provide a downlink multi-user transmission, where multiple users may be distinguished from each other by a spatial mapping. For example, in an IEEE 802.11ac based system, downlink MU-MIMO transmissions using up to multiple STAs (e.g., four STAs) may be provide.

In an 802.11 based system, transmission to and/or reception from a single STA in a time slot may be provided. For example in an IEEE 802.11ac based system, a multi-user MIMO transmission may utilize spatial diversity to enable simultaneous transmissions to multiple users. In such configurations, physical layer transmission and/or reception designs may be provided for single user transmission. In systems, for example, based on OFDMA like multi-user access transmission (e.g., a COBRA transmission) STAs may use different frequency sub-channels for simultaneous transmission. The multi-user access transmission STAs for a particular COBRA group may include provisions for addressing one or more of carrier frequency, sampling frequency, timing offset, or transmit power offset differences between the individual STAs. These provisions may be provided to support multi-user transmission and reception on one or more sub-channels. The systems that utilize COBRA resource allocation schemes among multiple users may use enhanced transceivers.

A transceiver (e.g., a COBRA enabled transceiver) is disclosed that may provide support for multiple transmitters (STAs) and a receiver (AP) in a downlink and/or an uplink (UL) COBRA transmission. The transceiver may comprise one or more of the features described herein. The transceiver may enable one or more of synchronous carrier frequency, synchronous timing, or transmit power alignment for each of the STAs in a multi-user group scheduled for simultaneous transmission. The transceiver may include an uplink transmitter (e.g., an uplink COBRA transmitter) and/or a receiver (e.g., a COBRA receiver). It may be assumed that the transmitter and the receiver may be capable of operating on a set of wideband COBRA channels and each of the COBRA sub-channels.

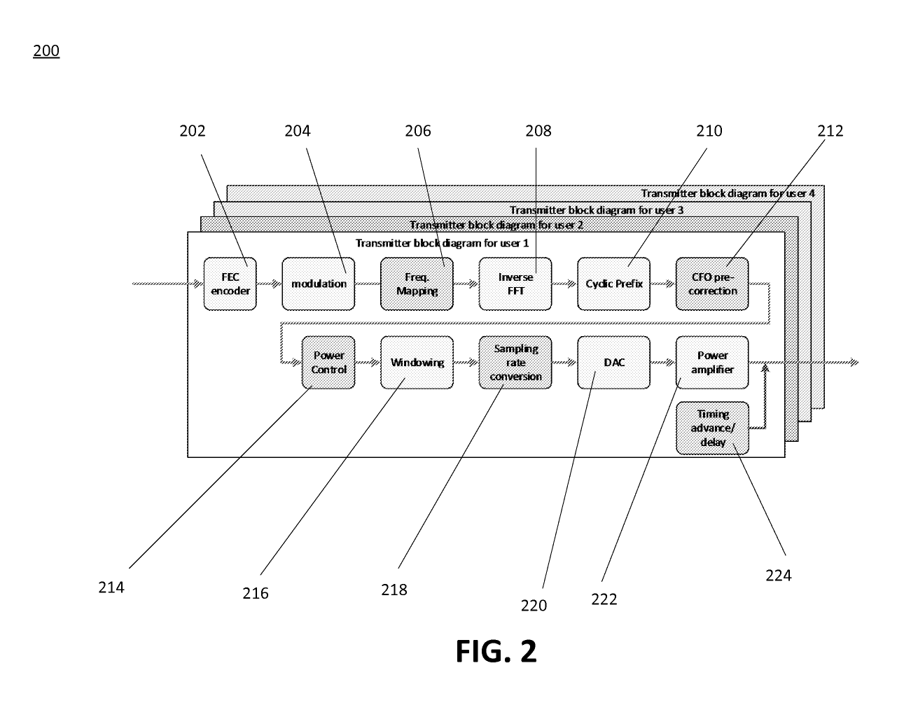

FIG. 2 illustrates an example transmitter 200 (e.g., an UL COBRA transmitter). As illustrated in FIG. 2, an UL COBRA transmitter 200 may include and/or perform one or more of the following: an FEC encoder 202 (e.g., may perform FEC encoding), modulation 204 (e.g., which may be performed via a modulator), frequency mapping 206, inverse FFT 208, cyclic prefix 210, Carrier Frequency Offset (CFO) pre-correction 212, power control 214, windowing 216, sampling rate conversion 218, a digital to analog converter or DAC 220, a power amplifier 222, or timing advance/delay 224, etc.

UL COBRA may also be referred to as UL MU-OFDMAFDMA and/or UL MU-COBRA.

As illustrated in FIG. 2, in an UL COBRA system, multiple transmitters (e.g., multiple transmitters for multiple users) may transmit at the same time. Each of the transmitters may use the same carrier frequency and/or sampling frequency, e.g., to receive and decode each of the signals correctly. Each of the transmitted signals may arrive at the receiver at the same time, with the same individual received power. In practice, that may not be the case. The signals may be adjusted to compensate for practical conditions (e.g., noise and/or interference). One or more of the transceiver blocks (e.g., features) may help compensate for the practical conditions. The blocks may include one or more of a power control block, a timing advance block, a sampling rate conversion block, or a carrier frequency offset block.

The power control block may modify the transmit power of a transmitter (e.g., of a transmitting station), such that the received power level received at an AP from the transmitter in consideration is comparable and/or identical to the received power level at the AP from other transmitters. For example, the AP may send an instruction (e.g., a configuration, which may be a transmission configuration) to a station to adjust its transmission power, e.g., as disclosed herein.

A timing advance block may be provided. The timing advance block may adjust transmissions, e.g., so that the signals are received within a cyclic prefix at the AP. For each of the transmitters, a timing advance value (e.g., a different timing advance value for each transmitter) may be applied. The timing advance may be estimated from data exchange(s), e.g., where an AP may estimate the uplink timing delay of a STA individually by measuring a round trip delay between a transmission time and a received acknowledgment (“ACK”) from each STA. The Sampling Rate Conversion block may skip and/or add samples to the transmitted signal, e.g., to compensate for a faster or slower clock at the STA with respect to the AP.

The Carrier Frequency Offset (CFO) pre-correction block may pre-correct a CFO experienced by the transmitter. The CFO may be defined as the carrier frequency offset between the receiver and the transmitter in consideration. The pre correction of CFO may be estimated from a previous downlink session, e.g., where each device estimates the CFO individually using the downlink header fields and/or pilot.

Transmit power control and rate adaptation may be provided. When multiple STAs transmit at the same time to a common AP, the received signal levels may be different, e.g., due to different path loss and/or shadowing. Signals from a nearby STA may be received with high signal levels, while the signals from a faraway STA may be received with weak signal levels. Such difference in signal levels may make it difficult to recover the weak signal (e.g., weak short/long training fields) from the composite received signals. Transmit power control may be provided to compensate for such a difference in signal levels. For example, a faraway STA may increase its transmit power, and a nearby STA may reduce its transmit power level. With such adjustment of transmit power levels, the signals from different STAs may arrive at the receiver with a similar power level.

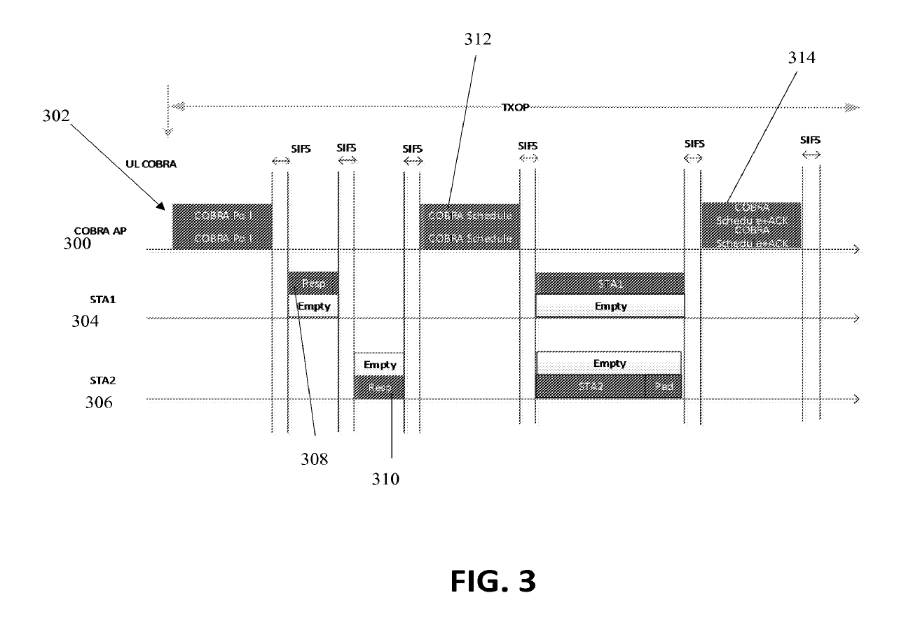

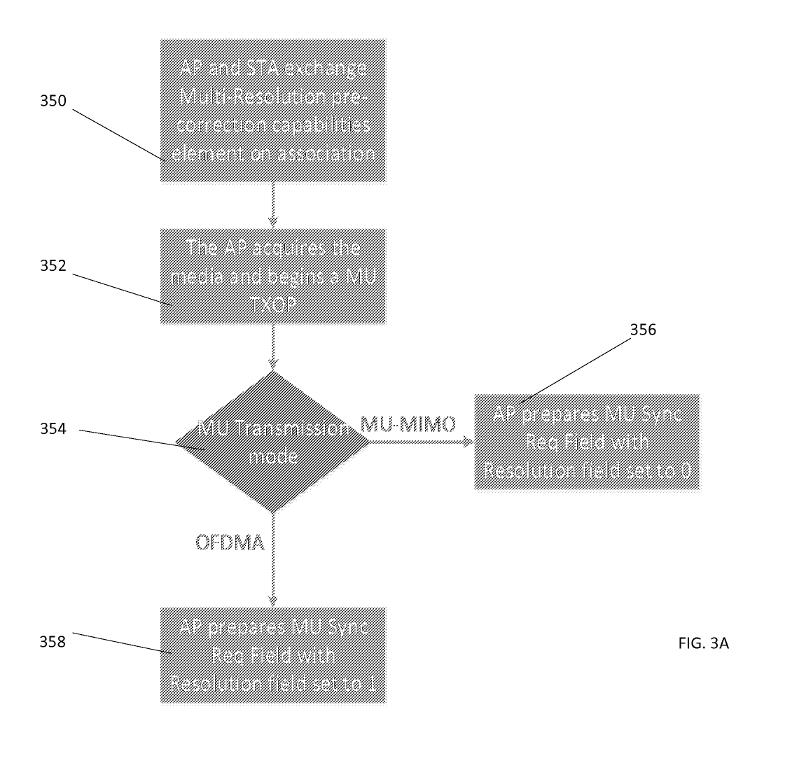

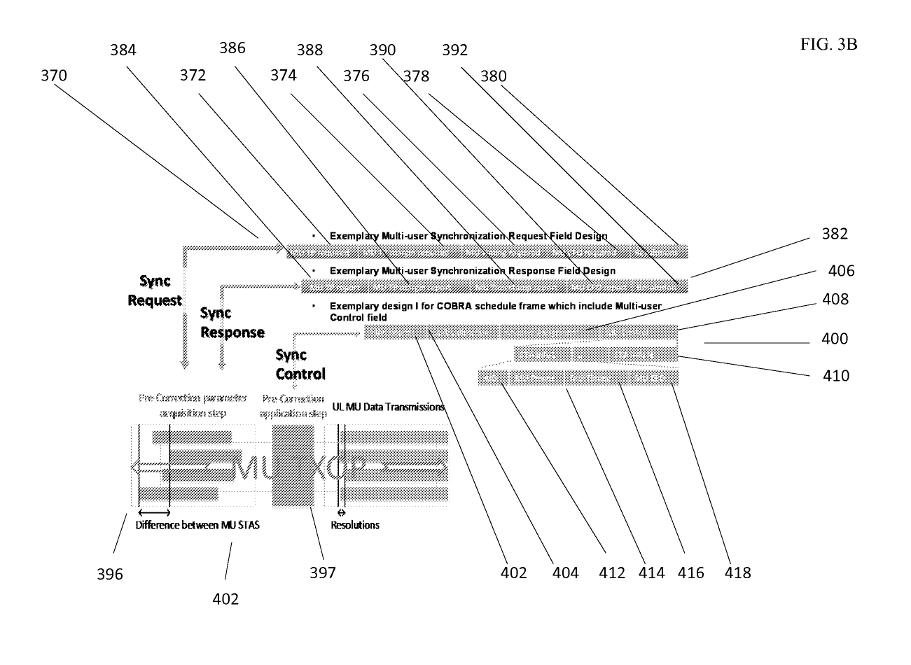

FIG. 3 illustrates an exemplary one channel access mechanism that may be used for a group of STAs that have been scheduled and/or identified for multi-user communications in a transmission opportunity (“TXOP”). One or more of the following may apply. As illustrated in FIG. 3, an AP (e.g., a COBRA AP) 300 may perform a COBRA poll 302 of each of the STAs 304, 306 that may belong to a group to determine the STAs that may have data to send. In the COBRA poll frame 302, the AP may request the intended STAs to report their transmit power, and other metrics that may be used for power control, for example, the transmit antenna gain, transmit headroom, etc. The AP may request a comprehensive margin index. The comprehensive margin index may include each of the metrics used for power control. The AP may indicate in the COBRA poll frame 302 that the STA should report transmit power levels of the entire bandwidth or the allocated sub-channel(s).

Each of the STAs may report its transmit power and/or other metrics or a comprehensive margin index within a COBRA response frame 308, 310. A STA may report the transmit power and/or related metrics over the entire band, e.g., if the STA transmits the COBRA response frame 308, 310 over the entire bandwidth. A STA may report the transmit power and related metrics over the operating sub-channel(s), e.g., if the STA transmits over a sub-channel or several sub-channels. The STA may report the transmit power and/or related metrics of the sub-channel(s) assigned to it. In the COBRA response frame 308, 310, one or more bits may be utilized to indicate whether the transmit power and/or related metrics reported are for the entire bandwidth or one or more sub-channels.

The AP may perform a measurement, for example the RSSI, of the response frame(s) for each of the STAs. The measured RSSI may be for the entire bandwidth or for a COBRA/OFDMA resource to be used. If the RSSI measurement is for a COBRA/OFDMA frequency or sub-channel resource, the measurement may be referred to as a sub-channel RSSI. The AP may determine whether a STA should increase/reduce its transmit power and by how much the STA should adjust the transmit power. The AP may make such determination, e.g., by using the measured RSSI, the sub-channel RSSI, the reported transmit power, the reported transmit power headroom, and/or other margins. The STA may calculate the required transmit power, e.g., using the information provided by the AP. The user power control may apply to COBRA data transmission. The user power control may apply to a COBRA data frame, e.g., if the power control is not signaled in the COBRA schedule frame. The RSSI measurement may be applied on the assigned sub-channel(s) or the entire bandwidth.

The AP may send the desired transmit power for each of the STAs or a group of STAs in a COBRA schedule frame (e.g., a current COBRA schedule frame) 312. The transmit power value may be the exact transmit power for a STA or the value the STA may adjust its power by. The transmit power value may be limited by the maximum transmit power capability of the STA(s) or a pre-configured maximum transmit power. The AP may re-evaluate the UL COBRA group, e.g., when power alignment cannot be met with the current group of STAs that have been scheduled or when other grouping strategy is applied. The COBRA poll and response frames may include additional fields to make the TPC request, TPC response, and TPC adjustments as described above.

The one channel access mechanism as illustrated in FIG. 3 may be applied with other channel access schemes, or other one-to-one frame interchange mappings, between an AP and each STA, or group of STAs. The modulation and coding scheme (MCS) scheduled for each STA may be the same or different.

Timing synchronization offset may be provided. In uplink MU-MIMO, multiple stations may transmit together (e.g., simultaneous transmissions). Transmitted packets may arrive at the receiver (e.g., AP) at different distinct time instants, e.g., because the AP may have different round-trip propagation delays and/or processing delays from each of the STAs. Timing advance may be used to alleviate this issue. For example, the STA(s) with a large propagation delay(s) may begin transmission early, while a STA(s) experiencing a small propagation may begin transmission later. The AP may measure the transmission time and response time for a STA. The STA may use the transmission time for sending an acknowledgment (ACK) to the AP. The AP may maintain a list of propagation delays for each STA. The AP may use this list and/or other factors described herein for identification of STAs to group together for subsequent associated UL-COBRA transmissions. The AP may use this information to estimate the time advance required for each of the STAs or a group of STAs. This information may be sent to each STA, e.g., in an action frame, providing an indication of the start of a transmission 314.

As illustrated in FIG. 3, using the exemplary channel access scheme time synchronization may be provided, which may include one or more of the following. An AP (e.g., a COBRA AP) may perform a COBRA poll 302 of each of the STAs (e.g., the STAs belonging to a group), e.g., to determine that the STAs have data to send. In the COBRA poll frame, the AP may request the intended STAs to report the timestamp of a response frame. Within the COBRA response frame 308, 310, the k^{th} STA may report its own timestamp T0ₖ. The AP may record the time of arrival for the k^{th} STA as T1ₖ. According to T0ₖ, T1ₖ and the transmission order and a duration of a COBRA Response frame, the AP may determine the total of propagation delay and processing delay of the k^{th} STA and may record it as Δₖ. The AP may collect each of the Δₖ, k=1, . . . , K and may determine the timing correction Tₖ for each of the STAs. A positive value of Tₖ may represent a time delay and a negative value may represent a time advance, or vice versa. The AP may quantize the Tₖ and send the quantized Tₖ to the STAs, e.g., in a COBRA schedule frame 312. The STAs may receive the Tₖ and apply timing delay or advance as illustrated in FIG. 2. The AP may redefine the UL COBRA group when timing correction may not be met (e.g., when the time difference between STAs is too great) with the current group of STAs, or when another grouping strategy is applied. In the time synchronization described above, one-way delay may be utilized for timing correction.

An AP may utilize transmission round trip delay to calculate a timing correction. Time synchronization utilizing the round trip delay may be provided, which may include one or more of the following. An AP may perform a COBRA poll 302 of each of the STAs and record the timestamp of the COBRA poll frame as T0. The k^{th} STA may reply to the poll frame, e.g., using a COBRA response frame 308, 310. The AP may record the time of arrival of the response frame. According to the transmission order of the k^{th} STA and duration of COBRA poll and COBRA response frames, the AP may estimate a time of arrival of the COBRA response frame. Using the difference between the estimated time of arrival and real time of arrival, the AP may estimate the propagation and the processing delay of the k^{th} STA as Δₖ. The AP may collect each of the Δₖ, k=1, K and determine the timing correction Tₖ for each of the STAs. A positive value of Tₖ may represent a time delay and a negative value may represent a time advance, or vice versa. The AP may quantize the Tₖ and send the quantized Tₖ to the STAs in the COBRA schedule frame 312. The STAs may receive the Tₖ and perform timing delay or advance as illustrated in FIG. 2. The AP may redefine the UL COBRA or an UL MU-MIMO group (e.g., when the timing correction may not be met (e.g., when the time difference between STAs is too great)) with the current group of STAs, or when another grouping strategy is applied. The time synchronization example described above may be based on an uplink channel access scheme as illustrated in FIG. 3. The time synchronization may be applied with other channel access schemes, or other one-to-one frame interchange mappings, between an AP and each STA, or group of STAs.

Sampling frequency offset may be provided. Each of the STAs (e.g., including the transmitting STAs and/or the receiving AP) may derive its local oscillator and clock signals from a controlled oscillator. This may lead to an oscillator mismatch and may cause carrier frequency offsets (CFO) and sampling clock offsets (SCO), between the transmitters and the receiver. In 802.11 systems where one transmitter is involved, SCO may be corrected at the receiver by robbing and/or skipping (e.g., if the receiver sampling clock is slower) or stuffing and/or adding (e.g., if the receiver sampling clock is faster) a sample in the time domain within a regular interval.

A similar process may be provided at the transmitter side, e.g., for UL COBRA or UL MU-MIMO. For example, each of the STAs may estimate the reference sampling clock of the AP separately, e.g., by receiving downlink data/control frames (e.g., beacon frames) from the AP. Each of the STAs may pre-correct the SCO at the transmitter side by robbing and/or skipping (e.g., if the transmitter sampling clock is faster) or stuffing and/or adding (e.g., if the transmitter sampling clock is slower) a sample in the time domain within a regular interval. The same logic in SCO correction from an IEEE 802.11 based receiver may be reused.

Carrier frequency offset (CFO) may be provided. In single-transmitter-single receiver transmissions in 802.11, CFO may be estimated and/or corrected at the receiver side. For downlink COBRA where multiple receivers are present, different receivers may apply CFO estimation and correction separately.

In UL COBRA, detection of CFO from joint time domain signals from multiple users may not be adequate. And higher CFO values may create inter-user interference. A multi-step CFO correction may be provided. The multi-step CFO correction may address such issues. A CFO correction may be applied at the transmitter side and/or the receiver side. As illustrated in FIG. 3, using an uplink channel access scheme as an example, CFO correction at the transmitter side may be performed, which may include one or more of the following. An AP (e.g., a COBRA AP) may perform a COBRA poll of each of the STAs, e.g., using a COBRA poll frame. In a COBRA poll frame, the AP may request the intended STAs to report the estimated CFO between an AP and the STAs. The CFOs may be estimated (e.g., estimated independently) at a STA (e.g., via receiver processing of downlink preambles in a COBRA poll frame). The CFO may be estimated over the entire bandwidth or certain sub-channel(s). For example, assuming that there is a normalized carrier frequency offset between the receiver carrier frequency and the transmitter carrier frequency generated by the oscillators of θ, the time domain signal x(n) may be represented as:

$$x ( n ) = \frac{1}{\sqrt{N}} {\sum }_{k = 0}^{N - 1} X ( k ) {e}^{j2 π n ( k + θ ) / N}$$

where {X(k)} may be the frequency domain signals, with k being the subcarrier index, and n being the time domain sample index. The receiver may use preamble to estimate the CFO θᵢ for i^{th} STA. The STA may send this information to the AP, e.g., through a COBRA response frame.

The AP (e.g., using a COBRA schedule frame) may request the i^{th} STA to pre-correct the CFO by \hat{θ}ᵢ, where \hat{θ}ᵢ may or may not be the same as θᵢ. The CFO may be pre-corrected to align the uplink transmissions from multiple STAs.

One or more STAs may perform CFO pre-correction. The pre-corrected signal (e.g., assuming time domain correction) may be:

$$\hat{x} ( n ) = ( \frac{1}{\sqrt{N}} {\sum }_{k = 0}^{N - 1} X ( k ) {e}^{j 2 π n ( k + θ ) / N} ) \cdot \{ {e}^{- j 2 π n \hat{θ} / N} \}$$

where e^{-j2πn\hat{θ}/N} may be the pre-correction factor to accommodate the CFO. Different pre-correction methods may be used (e.g., Taylor series expansion based approximation, frequency domain interpolation, etc.).

CFO pre-correction may be provided, which may include one or more of the following. An AP may perform a COBRA poll of each of the STAs. The AP may require the STAs to reply, e.g., via response frames one by one sequentially, and the order may be indicated explicitly or implicitly, e.g., in group ID. The STAs may send response frames, e.g., send the response frames one by one sequentially. The AP may measure CFO, for example each respective CFO, e.g., via the response frame transmitted from each STA to the AP. The CFO may be estimated over the entire bandwidth or certain sub-channel(s). For example, assuming that there is a normalized carrier frequency offset between the receiver carrier frequency and the transmitter carrier frequency generated by the oscillators of θ, the time domain signal x(n) may be represented as:

$$x ( n ) = \frac{1}{\sqrt{N}} {\sum }_{k = 0}^{N - 1} X ( k ) {e}^{j 2 π n ( k + θ ) / N}$$

where {X(k)} may be the frequency domain signals, with k being the subcarrier index, and n being the time domain sample index. The receiver may use preamble to estimate the CFO θᵢ for i^{th} STA.

The AP (e.g., using a COBRA schedule frame) may request the i^{th} STA to pre-correct the CFO by \hat{θ}ᵢ, where \hat{θ}ᵢ may or may not be the same as θᵢ. The CFO may be pre-corrected to align the uplink transmissions from multiple STAs.

One or more STAs may perform CFO pre-correction. The pre-corrected signal (e.g., assuming time domain correction) may be:

$$\hat{x} ( n ) = ( \frac{1}{\sqrt{N}} {\sum }_{k = 0}^{N - 1} X ( k ) {e}^{j 2 π n ( k + θ ) / N} ) \cdot \{ {e}^{- j 2 π n \hat{θ} / N} \}$$

where e^{-j2πn\hat{θ}/N} may be the pre-correction factor to accommodate the CFO. Different pre-correction methods may be used (e.g., Taylor series expansion based approximation, frequency domain interpolation etc.). When each user pre-corrects the signal using estimated θ, common phase error may be corrected.

CFO pre-correction described herein may be based on an uplink channel access scheme as illustrated in FIG. 3. The CFO pre-correction may be applied using other channel access schemes or other one-to-one frame interchange mappings, between an AP and each of the STAs, or group of STAs.

CFO estimation and/or CFO pre-correction values may be signaled and transmitted between transmitter and receiver. These values may present angles (in radians), frequencies (in Hz or ppm), and they may be quantized for transmission.

The CFO pre-correction may be utilized to pre-correct timing, frequency, power, and/or sampling offset. The pre-correction 395, as shown in FIG. 3B, may comprise pre-correction parameter acquisition 396 and/or pre-correction application 397.

In pre-correction parameter acquisition 396, the AP and the STA(s) may utilize frame exchanges between them to exchange requests and responses of certain measurements. The requests and responses of certain measurements may be utilized for pre-correction in uplink multiple user transmissions. For example, for an AP performing COBRA poll of each of the STAs requesting to report transmit power and related metrics, a STA reporting the transmit power and the related metrics and the AP performing measurement, as described herein, may be considered as pre-correction acquisition. For example, for an AP performing COBRA poll of each of the STAs, a STA reporting a timestamp value and the AP determining the timing correction value for each of the STAs, as described herein, may be considered as pre-correction acquisition. For example, for an AP performing COBRA poll of each of the STAs and recording the timestamp, a STA responding with a COBRA response frame and the AP determining the timing correction value for each of the STAs, as described herein, may be considered as pre-correction acquisition. For example, for an AP performing COBRA poll of each of the STAs, a STA sending the estimated CFO to the AP via a COBRA response frame, as described herein, may be considered as pre-correction acquisition.

In pre-correction application 397, an AP may collect the information from each of the potential uplink simultaneous users through pre-correction parameters acquisition and apply it on the group of uplink simultaneous users. For example, the AP sending the desired transmit power or power adjustment for each STA, or group of STAs, e.g., in the current COBRA schedule frame, as described herein, may be considered as pre-correction application. For example, the AP quantizing the Tₖ and sending the quantized value to the STAs, e.g., using a COBRA schedule frame, and the STAs receiving the Tₖ, and performing timing delay or advance, as described herein, may be considered as pre-correction application. For example, the AP requesting the STA to pre-correct the CFO, e.g., using a COBRA scheduling frame, and the STA performing CFO pre-correction, as described herein, may be considered as pre-correction application.

Pre-correction parameter acquisition 396 may include one or more of the following. The STA may perform pre-correction parameter acquisition 396 with an AP multiple times, e.g., with different frame exchange mappings. Frame exchanges, that may be utilized to perform pre-correction and acquire pre-correction parameters, may include one or more of the following. A COBRA pre-correction information element or other uplink simultaneous transmission information elements may be included in the management frames, (e.g., when the STA associates with the AP) such as using probe request/response frames, association request/response frames, etc. Frame exchanges for uplink random access may be used. The uplink random access frame may include a MAC body which may include the pre-correction request/response information. Normal data/ACK frame exchanges may be used. The data/ACK frames may be aggregated with a frame that may include the pre-correction field. The MAC header of the data/ACK frames may include a pre-correction field and may be used. The ACK frame may be modified to accommodate the changes. COBRA control frames, e.g., transmitted before the uplink COBRA session, may be used. Other uplink simultaneous transmission control frames, e.g., transmitted before the uplink simultaneous transmissions, may be used.

One or more of the following may be applied in pre-correction, e.g., pre-correction application 397. The parameters applied for pre-correction may include one or more of the following. The pre-correction parameters acquired by the latest pre-correction may be used for pre-correction. The pre-correction parameters may be a function of each of the past acquired pre-correction parameters. For example, the function may be a weighted average, a moving average, etc.

One or more of the pre-correction parameters may be signaled, e.g., by an AP signaling with an absolute pre-correction value and/or a differential pre-correction value. The absolute value and/or the differential value may be quantized.

The frames which may be utilized to signal the pre-correction parameters may include one or more of the following: a COBRA schedule frame, a COBRA poll frame, a schedule frame (e.g., for other uplink simultaneous transmission schemes), or a poll frame, (e.g., for other uplink simultaneous transmission schemes).

Multi-resolution pre-corrections may be provided, e.g., to support different requirements for simultaneous uplink transmissions. As described herein, COBRA and COBRA uplink access may be utilized as examples. Other simultaneous uplink transmissions, e.g., uplink MU-MIMO transmissions may be available for future Wi-Fi systems. Simultaneous uplink transmissions may utilize synchronization of multiple users in time domain, frequency domain, and/or power domain. Different uplink transmission schemes may have different levels of synchronizations. For example, UL MU-MIMO may have uplink intended STAs with different synchronization level than STAs with uplink COBRA. The resolution information may be signaled as described herein. An AP may broadcast a multi-resolution pre-correction capabilities element in a beacon frame or a probe response frame. The STAs may report the multi-resolution pre-correction capability in an association request frame or a probe request frame. Table 1 illustrates an example of a multi-resolution pre-correction capabilities element

TABLE 1

| | | |
|---|---|---|
| Element ID | Length | Multi-resolution pre-correction capabilities |

As illustrated in Table 1, the multi-resolution pre-correction capabilities may include multi-resolution timing pre-correction enabled, multi-resolution frequency pre-correction enabled, and/or multi-resolution transmit power enabled, etc. With pre-correction parameter acquisition, the AP and the STA may exchange request and response for pre-correction parameters with a specified resolution. In the request, the transmitter (e.g., STA) may indicate the desired resolution. The receiver may or may not follow the instruction of the transmitter. The receiver may respond with the pre-correction parameters with a specified resolution.

An AP and/or a STA may use a multi-user synchronization request field/information element (IE) to request a STA or a group of STAs to report one or more synchronization related parameters. This field/IE may be included in a COBRA poll frame or other related management and control frames. An exemplary design of the multi-user synchronization request field/IE may include one or more of a multi-user power control required field, a multi-user timing synchronization required field, or a multi-user CFO required field.

The multi-user power control required field may include a transmit power required subfield, a transmit power margin required subfield, etc. The multi-user power control required subfield(s) may be utilized to indicate whether the receiver(s) may report the transmit power and/or transmit power margin to the transmitter. The multi-user power control required subfields may indicate resolution of the required transmit power or it be indicated in a separate field.

The multi-user timing synchronization required field may utilize a timestamp subfield for multi-user synchronization. A timestamp may be an 8 octet field, e.g., as utilized in IEEE 802.11 specifications. A timestamp with higher resolution may be utilized for multi-user timing synchronization. In this case, the increased resolution may be communicated to the STA. A resolution of the timestamp subfield may be included in the multi-user timing synchronization required field or in a separate field. The multi-user timing synchronization field may include a timestamp required subfield and/or a timestamp present subfield.

A timestamp required subfield may be included, e.g., when time synchronization using one way delay for timing correction is used. This sub-field may be used to request that the responding STA (receiver) report the timestamp in the responding frame.

A timestamp present subfield may be included, e.g., when time synchronization using two way delay for timing correction is used. The timestamp present subfield setting of 1 indicates that a timestamp of current transmission is included in the current frame.

A multi-user CFO required field may include a CFO required subfield, and if this subfield is positive, a CFO resolution subfield may follow. The CFO required subfield may be 1, (e.g., when CFO pre-correction is utilized), where the CFOs may be estimated independently at the STA side, e.g., as described herein. The CFO required subfield may be 0, (e.g., when CFO pre-correction is utilized), where the AP measures the CFO based on the response frame from a STA, as described herein. This is shown in FIG. 3A. The AP and the STAs may exchange multi-resolution precorrection capabilities element 350. The AP may acquire the media and may begin a multiuser TXOP 352. The AP may determine whether the multiuser transmission mode is MU-MIMO or OFDMA 354. If the multiuser transmission mode is MU-MIMO, the AP may prepare 356 a multiuser synchronization with the required file with the resolution set to 0. If the multiuser transmission mode is OFDMA, the AP may prepare 358 a multiuser synchronization with the required file with the resolution set to 1.

Table 2 illustrates an example of a multi-user synchronization request Field/IE. As illustrated in Table 2 and FIG. 3B, a multi-user synchronization request field/IE 370 may include one or more of a multi user transport protocol (“MU TP”) required subfield 372, a MU TP margin required subfield 374, a multi user (“MU”) timing required subfield 376, MU CFO required subfield 378, or a resolutions subfield 380. The MU TP required subfield 372 may indicate whether the receiver may report transmit power for multi-user synchronization. The MU TP margin required subfield 374 may indicate whether the receiver may report a transmit power margin.

TABLE 2

| | | | | |
|---|---|---|---|---|
| MU TP | MU TP margin | MU Timing | MU CFO | Resolutions |
| required | required | required | required | |

As illustrated in Table 2 and FIG. 3B, the MU timing required subfield 376 may indicate whether the receiver may report a timestamp of its next transmission. The MU CFO required subfield 378 may indicate whether the receiver may report the estimated CFO. The resolutions subfield 380 may be present when at least one of the previous fields are non-zero. The MU CFO required field 378 may be 1 for resolution set I, e.g., with {x1 Bytes/Bits for TP; x2 Bytes/Bits for TP margin; x3 Bytes/Bits for timestamp; and x4 Bytes/Bits for CFO}. The MU CFO required field may be 0 for resolution set II, e.g., with {y1 Bytes/Bits for TP; y2 Bytes/Bits for TP margin; y3 Bytes/Bits for timestamp; and y4 Bytes/Bits for CFO}.

The resolutions subfield 380 may be a bitmap. Each bit may represent one component from a component set. The exemplary component set may be {TP, TP margin, timestamp, and/or CFO} and each component may have two resolution levels. One or more (e.g., two) resolution levels may be utilized.

Table 3 illustrates an example of a multi-user synchronization request field/IE. This field/IE may be utilized in time synchronization where round trip delay may be used to calculate the timing correction. This filed may also be utilized in CFO pre-correction where an AP may measure a CFO via a response frame received from a STA. As illustrated in Table 3, in this multi-user synchronization request field/IE, an MU timing presented subfield may be provided instead of an MU time required subfield. The MU timing presented subfield may be followed by a timestamp subfield. The timestamp subfield may depend on the value of the MU timing presented subfield.

TABLE 3

| | | | | |
|---|---|---|---|---|
| MU TP | MU TP margin | MU Timing | Timestamp | Resolutions |
| required | required | presented | | |

The timestamp subfield may be used to inform the desired receiver(s) of the timestamp of the frame that includes the multi-user synchronization request field. The resolutions subfield may be the same as in Table 2 or it may not include the resolution for a timestamp and/or a CFO.

As illustrated in FIG. 3B, a STA may use a multi-user synchronization response field/IE 382 to report synchronization related parameters and may use the transmitter of FIG. 2 to communicate the parameters. Table 4 and FIG. 3B illustrate an example of a multi-user synchronization response field/IE 382. As illustrated in Table 4 and FIG. 3B, this field/IE 382 may include one or more of a MU TP Report subfield 384, a MU TP margin report 386, a MU timestamp report 388, a MU CFO report 390, and a resolution subfield 392.

TABLE 4

| | | | | |
|---|---|---|---|---|
| MU TP | MU TP margin | MU Timestamp | MU CFO report | Resolution |
| report | report | report | | |

The MU TP report subfield or multi-user power control response subfield may include a transmit power response, a transmit power margin response, etc. The resolution of these reports may follow the resolutions field 380 transmitted in the multi-user synchronization request field 380, or it may be specified later.

The multi-user timing synchronization response subfield 382 may include a timestamp of the current frame. The resolution of the timestamp may follow the resolutions subfield 392 transmitted in the multi-user synchronization request field 382 or it may be specified later. The multi-user timing synchronization response subfield 382 may be provided (e.g., when time synchronization may be utilized, for instance round trip delay may be used to calculate timing correction).

The multi-user CFO response subfields may include an estimated CFO response. The resolution field may follow the resolution field transmitted in the multi-user synchronization request field 380 or may be specified later.

The resolutions subfield may be utilized to specify a resolution of each of the subfields.

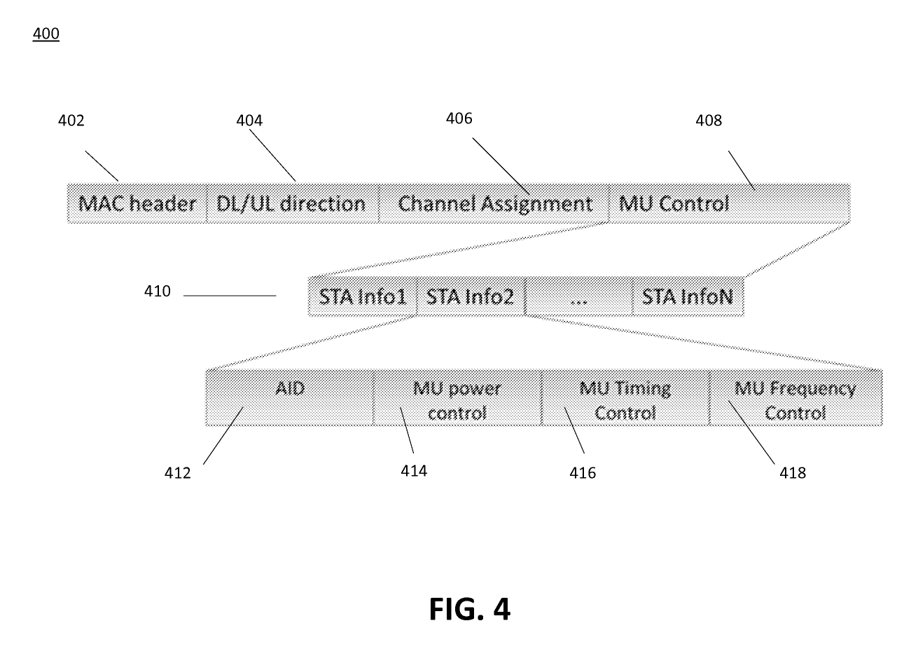

An AP may use a multi-user control field to indicate to one or more STAs to synchronize with the AP. The multi-user control field may be transmitted within a COBRA schedule frame. FIGS. 3B and 4 illustrates an example of a COBRA schedule frame 400 that may include a MAC header 402, a DL/UL direction 404, a channel assignment 406, and an MU control 408. As illustrated in FIG. 4, an MU control field 408 may include one or more STA information fields 410. Each STA information field 410 may include one or more of an AID subfield 412, an MU power control subfield 414, an MU Timing control subfield 416, or an MU frequency control subfield 418.

The AID subfield 412 may be associated with an identifier of a STA expected to be scheduled for upcoming COBRA transmissions. A compressed version of AID, or other IDs, may be utilized to distinguish STAs.

The MU power control subfield 414 may be the absolute or adjusted value of the transmit power. The MU power control subfield 414 may use less resolution than that in the synchronization request/response frames, e.g., if the value is an adjustment value. The MU power control subfield 414 may use the same number of bits/bytes as that in the synchronization request/response frames. The MU power control subfield 414 may use a different quantization method. The resolution and quantization method may be agreed to by the transmitter and the receiver or predefined in a specification.

The MU Timing control subfield 416 may be the expected time advance/delay value and may have the same resolution and format of timestamp(s) used in MU synchronization request/response frames. The MU Timing control 416 subfield may use less resolution than that in the synchronization request/response frames, e.g., if this subfield indicates an adjustment. The MU timing control subfield 416 may use the same number of bits/Bytes as that in the synchronization request/response frames. The MU timing control subfield 416 may use a different quantization method. The resolution and quantization method may be agreed to by the transmitter and the receiver or predefined in a specification.

The MU frequency control subfield 418 may indicate the CFO adjustment for the STA. The MU frequency control subfield 418 may use less resolution than that in the synchronization request/response frames, e.g., if this subfield indicates an adjustment. The MU frequency control subfield 418 may use the same number of bits/Bytes as that in the synchronization request/response frames. However, the MU frequency control subfield 418 may use a different quantization method. The resolution and quantization method may be agreed to by the transmitter and the receiver or predefined in a specification.

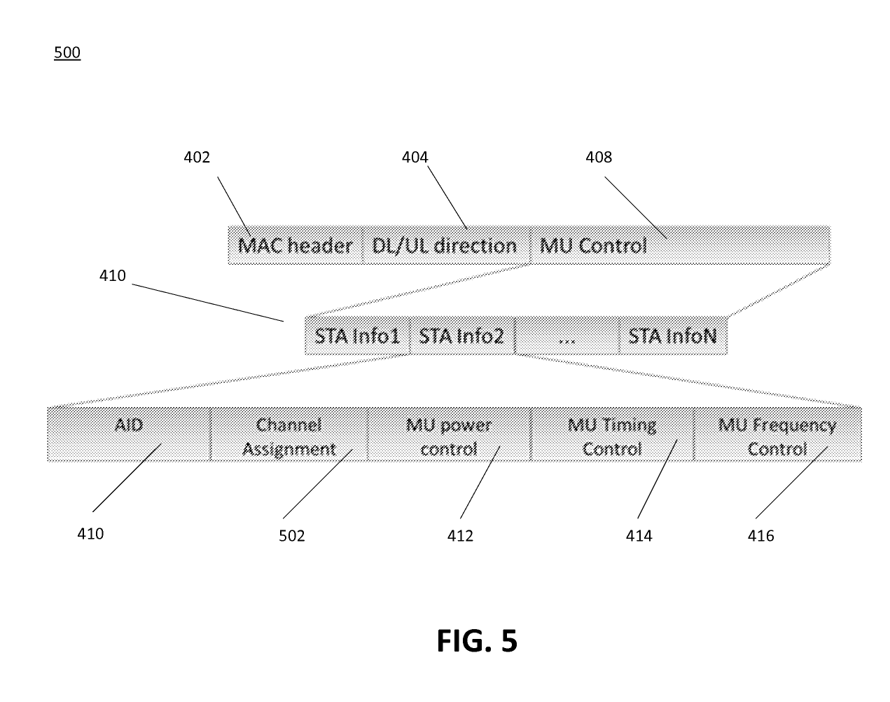

FIG. 5 illustrates an example of a COBRA schedule frame 500. As illustrated in FIG. 5, in addition to the fields provided in the COBRA scheduled frame of FIG. 4, a channel assignment subfield 502 may be included in the STA information subfield. The channel assignment subfield 502 may be used to signal the channel assignment for the particular STA.

An uplink COBRA receiver may be provided. An uplink transmitter may pre-correct the frequency, timing difference, sampling rate, and adjust the transmitter power. The pre-correction may align the signals within a signal level. An uplink transmitter may choose to not to pre-correct some of the parameters. In that case, correction for those parameters may be performed at receiver. At the receiver (e.g., at an AP) side, a fine timing, frequency, and phase correction may be applied to further align the signals and improve the physical layer performance

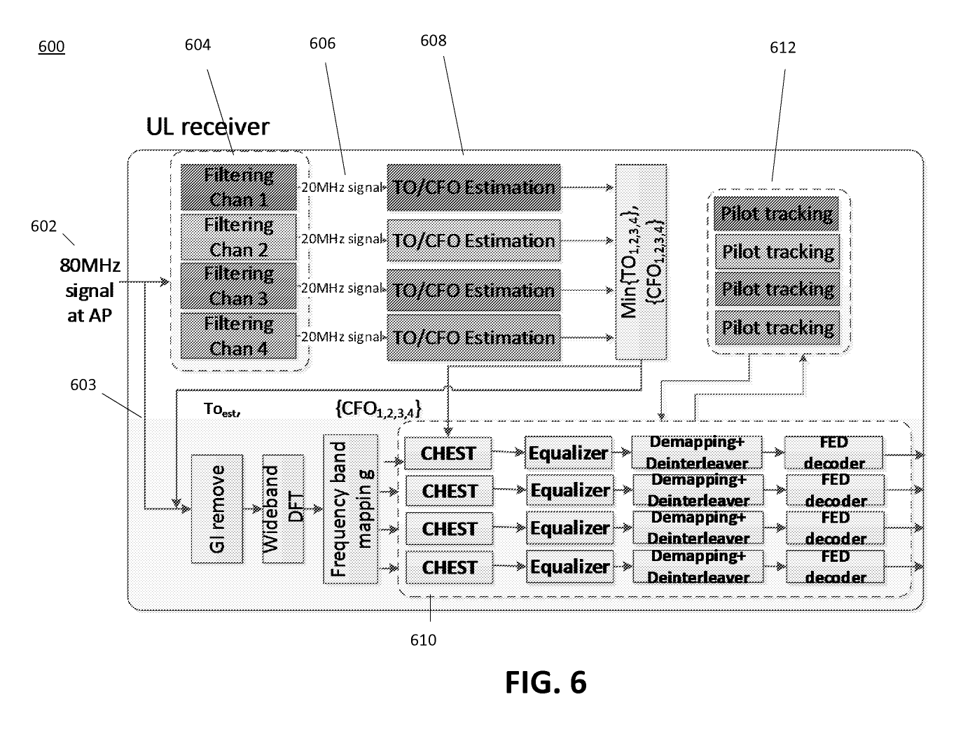

FIG. 6 illustrates an example of a receiver 600 for reception of an uplink COBRA transmission(s), e.g., by a COBRA AP. As illustrated in FIG. 6, when the AP receives a signal with multiple sub-channels (e.g., an 80 MHz signal 602 with four 20 MHz sub-channels), it may pass the 80 MHz signal (or a signal based on it) to the filters 604 for impairment estimation. The passed signal (or a signal based on it) 603 may also be used for receiver processing. The filters 604 may filter the signal on the desired sub-channel. For example, when a sub-channel (e.g., a 20 MHz sub-channel) is considered, four filters may be applied to the 80 Mhz signal. After filtering, four 20 MHz signals 606 on each sub-channel may be obtained. For each narrowband signal (e.g., the 20 MHz signals), timing offset (TO) and/or carrier frequency offset (CFO) may be estimated 608, e.g., using short training field (STF) and/or long training field (LTF) on the sub-channel. The estimated TOs and CFOs may be applied to the 80 MHz signals 610. A pilot tracking algorithm 612 may be applied to correct phase errors.

Timing offset and/or CFO correction at the receiver side (e.g., a COBRA receiver) may be provided. As illustrated in FIG. 6, a set of frequency domain filters 602 may be applied to a wideband signal to filter the signals on each of the sub-channels. With COBRA preamble design, each of the sub-channels may include its own short training field (STF) and long training field (LTF). As illustrated in FIG. 6, timing and/or frequency offset correction may performed. One or more of the following may be used.

As illustrated in FIG. 6, the AP may send the received signal (or signal based on the received signal) to a set of frequency filters. The AP may obtain a signal of each sub-channel. For a signal on the k^{th} sub-channel, the AP may perform timing and/or frequency offset estimation by checking the STF/LTF, e.g., using normal start-of-packet detection algorithms, such as auto-correlation, cross-correlation algorithms. The AP may record the estimated timing offset as TOₖ and carrier frequency offset as CFOₖ. The AP may repeat the timing and/or frequency offset estimation for each of the sub-channel signals. The AP may calculate one TO according to {TOₖ: k=1, . . . , K}, where K is the number of sub-channels. For example, TO=min(TOₖ). The AP may calculate one CFO according to {CFOₖ: k=1, . . . , K}, where K is the number of sub-channels. For example, CFO=mean(TOₖ). The AP may compensate the TO and/or the CFO in time domain, e.g., use the received wideband signal (or signal based on the received signal). The AP may remove a guardian interval and may perform Discrete Fourier Transform (DFT) processing to convert the signal from the time-domain to the frequency-domain. In the frequency domain, the AP may perform frequency band mapping. The AP may obtain signals for different STAs.

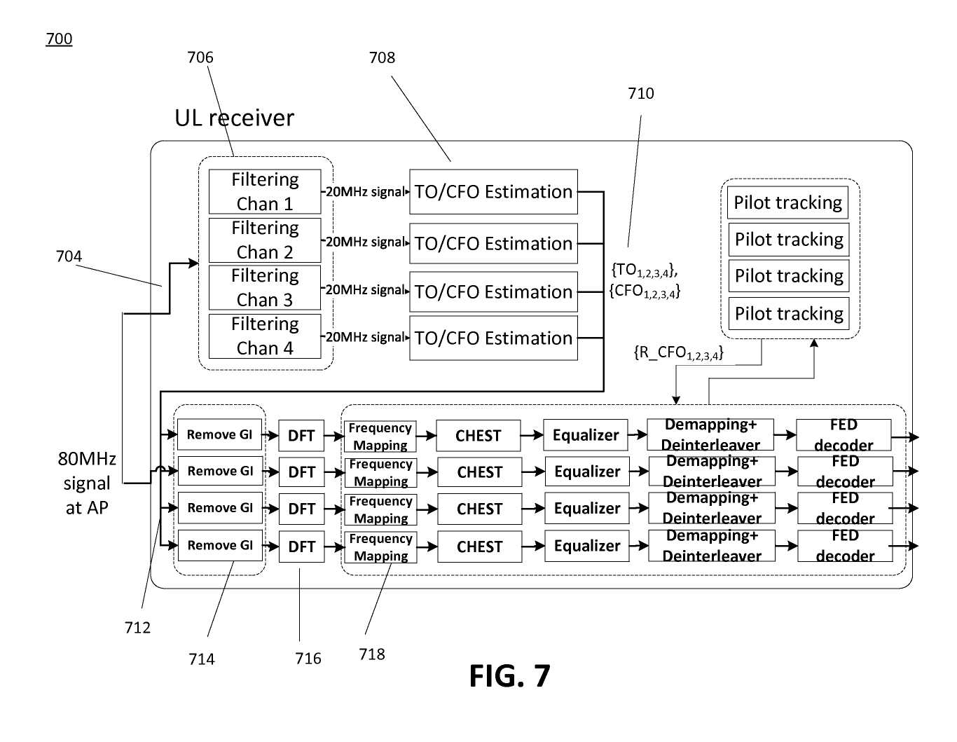

FIG. 7 illustrates an example of a receiver 700 for reception of an uplink COBRA transmission(s). As illustrated in FIG. 7, the timing/frequency correction may include one or more of the following. The AP may send the received wideband signal 704 (or signal based on it) to a set of frequency filters 706. The AP may obtain a signal for each of the sub-channels. For a sub-channel (e.g., k^{th} sub-channel), the AP may perform timing/frequency offset estimation 708, e.g., by checking the STF/LTF using normal start-of-packet detection algorithms, such as auto-correlation and/or cross-correlation algorithms. The AP may record the estimated timing offset 710 as TOₖ. The AP may record the estimated timing offset (TOₖ) and carrier frequency offset (CFOₖ) 710. The AP may apply 712 TOₖ and CFOₖ to the wideband signal 704 (or signal based in it) to compensate the timing offset and carrier frequency offset for the k^{th} sub-channel. The AP may remove the guardian interval 714 and perform DFT 716. In the frequency domain, the AP may perform frequency band mapping 718 and obtain the signal for the k^{th} sub-channel. The AP may repeat the performing of timing and/or frequency offset estimation. The AP may apply TOₖ and CFOₖ to remove the guardian interval, and perform the DFT on each signal for reception of the data on each of the sub-channels. The AP may collect frequency domain signals for the m^{th} STA. The AP may perform normal detection. The mth STA may be allocated to one or multiple sub-channels. In multiple sub-channel allocation, the AP may collect the frequency domain signal from the multiple sub-channels. The AP may perform data demodulation and decoding.

Common phase error correction at the receiver side (e.g., at a COBRA receiver, such as a COBRA AP) may be provided. With CFO correction at the both transmitter and receiver side, there might be residual phase errors. Systems, methods, and instrumentalities may be provided to estimate and/or compensate common phase error (CPE). CPE may be compensated at the AP side, e.g., via receiver processing of uplink pilot signals. Pilot subcarriers for each STA may be in a different sub-channel of the transmission; CPE for each of the STAs may be measured (e.g., measured independently) using the pilot sub-carrier of a respective STA. As illustrated in equation (1), the estimate of CPE for the i^{th} user cpeᵢ may be calculated as:

cpeᵢ=Σₙ₌₂^{Np}((h_{n,i}′h_{n,i})⁻¹h_{n,i}′y_{n,i}×p_{n,i}) (1)

where h_{n,i} may be the frequency domain channel response for the n^{th} pilot sub-carrier of the i^{th} user, and p_{n,i} may be the transmitted pilot symbol.

After the normalization an estimated

$$CPE = \frac{{cpe}_{i}}{\vert {cpe}_{i} \vert} ,$$

can be compensated for by multiplying the channel estimate of each sub-carrier for the i^{th} user by [symbol] . As the compensated channel estimates are used to decode the symbol, the CPE is removed for each user. One or more of the following may be used. An AP may perform a COBRA poll of each of the STAs to determine STAs that have data to send. Each of the STAs may measure its CFO, e.g., CFO with respect to the AP. The STA may pre-correct itself with an estimated CFO as illustrated in equation (1), e.g., in each following COBRA transmission. The pre-correction may be applied to COBRA frames. Each of the STAs may have pilots at predefined sub-carriers. The AP may receive each of the COBRA transmissions simultaneously. The AP may apply a frequency domain filter and a CFO correction and a timing correction at the receiver as described herein. The AP may estimate the CPE for each STA using the pilots and channel estimates on pilots. The AP may perform normalization. The AP may average the CPE for each pilot sub-carrier for individual STAs. The AP may compensate the channel estimations for each STA, e.g., with a respective normalized CPE. The AP may use the compensated channel estimates to equalize the data and separate the data for each of the STAs.

Link level simulations may be performed to evaluate the performance of uplink COBRA schemes. For example, an AP may operate on a channel (e.g., 80 MHz channel). The AP may transmit to and receive from four users through COBRA transmissions. Each of the user may be allocated a sub-channel (e.g., a 20 MHz sub-channel). The same modulation and coding scheme may be used for each of the COBRA users (e.g., MCS5, which refers to 64 QAM and rate 2/3 convolutional code).

In a scenario, a single data stream may be transmitted to and received from each of the users. The data streams can be represented by Nₛₛ=1, where Nss stands for the number of data streams. Packet size in this scenario may be 500 bytes. A single antenna at both the AP side and the STAs side may be used. In another scenario, two data streams may be transmitted to and received from each of the users, thus Nₛₛ=2. Packet size in this scenario may be 1000 bytes. The AP and the STAs may have two antennas.

Assuming that the channel models utilized in the simulations are IEEE 802.11 Channel B and Channel D, Channel B may have an RMS delay spread of 15 ns, and Channel D may have an RMS delay spread of 50 ns. The channel models may represent indoor multipath situations. Due to the difference of RMS delay spread, channel D may be more frequency selective than channel B. Random angle of arrivals (AoAs) and of departures (AoDs) may be chosen for different STAs.

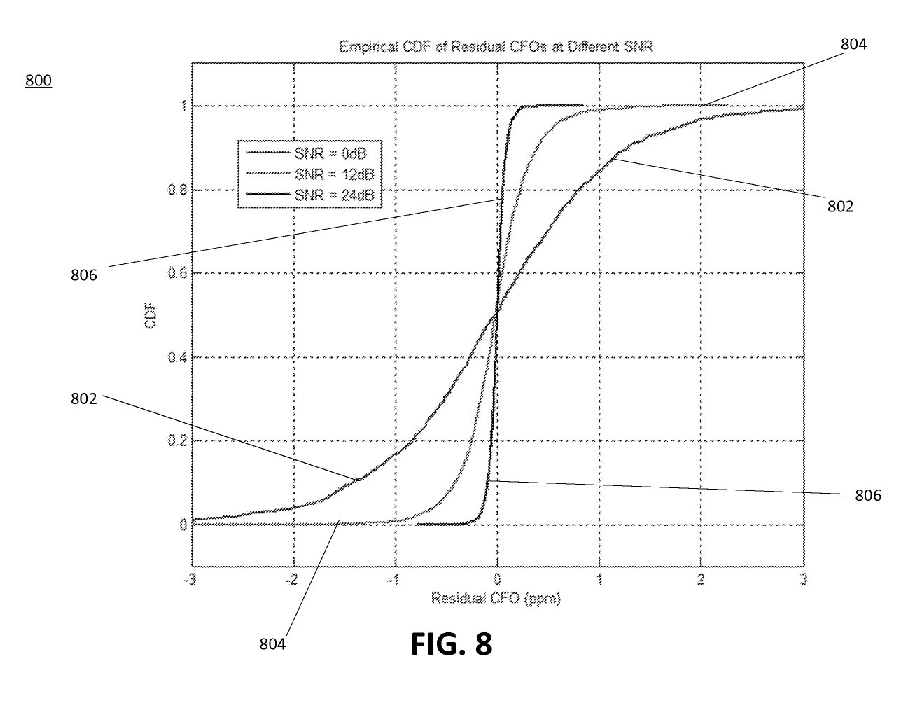

If the carrier frequency offset is pre-corrected at the transmitters and the first CFO correction at receiver side occurs after the sub-channel filter as illustrated in FIG. 6 and FIG. 7, the residual CFO may be modelled as a zero mean Gaussian distribution. The variance may be obtained by numerical simulation of a one to one transmission. The CFO may be corrected by using auto correlation or cross correlation on STF/LTF. FIG. 8 illustrates an example 800 of residual CFO distribution functions with the 0 SNR curve 802, the 12 dB SNR curve 804, and the 24 dB SNR curve 806. The variance of residual CFO may depend on different signal to noise ratios as illustrated in Table 5 and Table 6. Table 5 illustrates an example of variance of residual CFO on different SNR with a single antenna. Table 6 illustrates an example of variance of residual CFO on different SNR with two transmit antennas.

TABLE 5

| | | SNR (dB) | | | | | | | |
|---|---|---|---|---|---|---|---|---|---|
| | | 15 | 18 | 21 | 24 | 27 | 30 | 33 | 36 |
| Chan B | σ (in ppm) | 0.2525 | 0.1761 | 0.1228 | 0.0856 | 0.0597 | 0.0416 | 0.0290 | 0.0203 |
| | σ (in KHz) | 1.3131 | 0.9157 | 0.6386 | 0.4453 | 0.3105 | 0.2166 | 0.1510 | 0.1053 |
| Chan D | σ (in ppm) | 0.2079 | 0.1446 | 0.1006 | 0.0699 | 0.0486 | 0.0338 | 0.0235 | 0.0164 |
| | σ (in KHz) | 1.0809 | 0.7518 | 0.5229 | 0.3637 | 0.2530 | 0.1760 | 0.1224 | 0.0851 |

TABLE 6

| | | SNR (dB) | | | | | | | | |
|---|---|---|---|---|---|---|---|---|---|---|
| | | 21 | 24 | 27 | 30 | 33 | 36 | 39 | 42 | 45 |
| Chan B | σ | 0.0733 | 0.0509 | 0.0353 | 0.0245 | 0.0170 | 0.0118 | 0.0082 | 0.0057 | 0.0039 |
| | (in ppm) | | | | | | | | | |
| | σ | 0.3814 | 0.2646 | 0.1836 | 0.1274 | 0.0884 | 0.0613 | 0.0425 | 0.0295 | 0.0205 |
| | (in KHz) | | | | | | | | | |
| Chan D | σ | 0.0651 | 0.0450 | 0.0312 | 0.0215 | 0.0149 | 0.0103 | 0.0071 | 0.0049 | 0.0034 |
| | (in ppm) | | | | | | | | | |
| | σ | 0.3387 | 0.2342 | 0.1620 | 0.1120 | 0.0775 | 0.0536 | 0.0371 | 0.0256 | 0.0177 |
| | (in KHz) | | | | | | | | | |

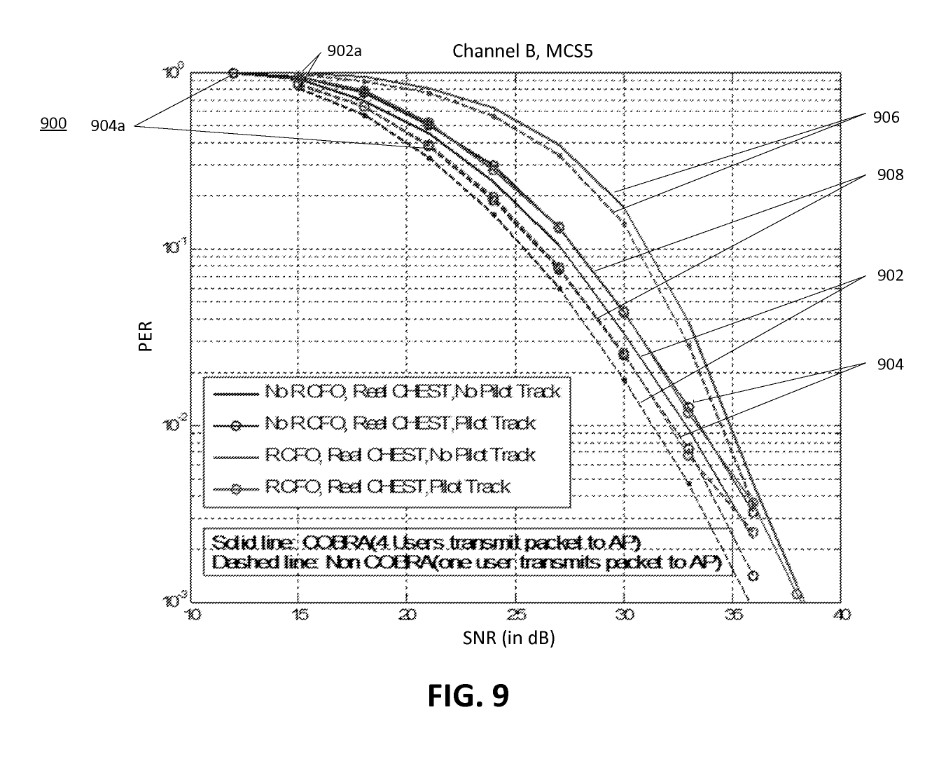

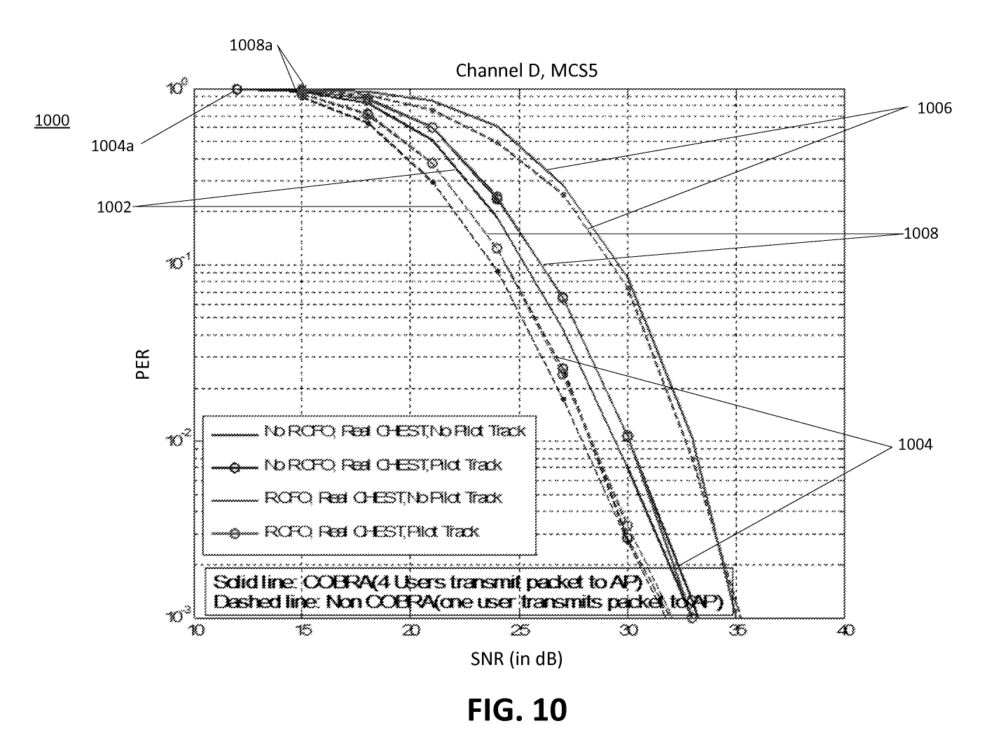

No timing offset between users and the similar received power levels from each of the users are assumed for the results in FIGS. 9 and 10. No phase noise or IQ imbalance is considered for the results in FIGS. 9 and 10. The residual CFO is corrected by pilot tracking. FIG. 9 illustrates an example 900 of simulation results of a single data stream uplink COBRA transmission over Channel B. FIG. 10 illustrates an example 1000 of simulation results of single data stream uplink COBRA transmission over Channel D. FIG. 9 shows the No RCFO, Reel CHEST, No Pilot Track 902; the No RCFO, Reel CHEST, Pilot Track 904; RCFO, Reel CHEST, No Pilot Track 906; and RCFO, Reel CHEST, Pilot Track 908. The tracks 904, 908 are almost on top of each other. The starting points 904a for curves 904 and the starting points 902a for curves 902 are shown. FIG. 10 shows the No RCFO, Reel CHEST, No Pilot Track 1002; the No RCFO, Reel CHEST, Pilot Track 1004; RCFO, Reel CHEST, No Pilot Track 1006; and RCFO, Reel CHEST, Pilot Track 1008. The tracks 1004, 1008 are almost on top of each other. The starting points 1004a for curves 1004 and the starting points 1002a for curves 1002a are shown.

Although SIFS is used to indicate various inter frame spacing, as described herein, each of the other inter frame spacing such as RIFS or other agreed time intervals may be applied.

Although features and elements are described above in particular combinations, one of ordinary skill in the art will appreciate that each feature or element may be used alone or in any combination with the other features and elements. Other than the 802.11 protocols described herein, the features and elements described herein may be applicable to other wireless systems. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, optical media such as CD-ROM disks, and digital versatile disks (DVDs). A processor in association with software may be used to implement a radio frequency transceiver for use in a WTRU, WTRU, terminal, base station, RNC, or any host computer.

1. An access point for associating with a wireless area network having one or more wireless stations, the access point comprising:
a processor configured to:
receive, within a single transmit opportunity, a respective metric and a respective resolution from each of a plurality of stations;
determine, within the single transmit opportunity, a group of compatible stations based on the respective metrics and the respective resolutions; and
send, within the single transmit opportunity, a respective configuration to each station in the group of compatible stations based on the respective metrics and the respective resolutions for each station to transmit within the single transmit opportunity.

2. The access point of claim 1, wherein the processor is further configured to receive, within the single transmit opportunity, a respective transmission from each station in the group of compatible stations.

3. The access point of claim 1, wherein the respective configuration comprises at least one of a respective power value or a respective frequency offset.

4. The access point of claim 1, wherein the respective metric comprises one or more of a respective power value currently being used by the respective station or a respective frequency offset currently being used by the respective station.

5. The access point of claim 1, wherein the respective resolution is associated with a type of uplink transmission from the respective station.

6. The access point of claim 5, wherein the type of uplink transmission is one of a multiple input-multiple output (MU-MIMO) transmission frequency division based signaling protocol or an orthogonal frequency-division multiple access (OFDMA) transmission.

7. An access point for associating with a wireless area network having a plurality of wireless stations that can each communicate with the access point via a single transmit opportunity that comprises a metric and a resolution, the access point comprising:
a processor configured to:
determine, within the single transmit opportunity, a group of compatible stations based on the metrics and the resolutions for each of the plurality of wireless stations; and
send, within the single transmit opportunity, a configuration to each of the plurality of wireless stations in the group of compatible stations based on the metrics and the resolutions for each station to transmit within the single transmit opportunity.

8. The access point of claim 7, wherein the configuration comprises at least one of a respective power value or a respective frequency offset.

9. The access point of claim 7, wherein the metric for each of the plurality of wireless stations comprises one or more of a power value or a frequency offset.

10. The access point of claim 7, wherein the resolution for each of the plurality of wireless stations is associated with an uplink transmission from each of the plurality of wireless stations.

11. The access point of claim 10, wherein the uplink transmission is one of a multiple input-multiple output (MU-MIMO) transmission frequency division based signaling protocol or an orthogonal frequency-division multiple access (OFDMA) transmission.

12. The access point of claim 7, wherein the processor is further configured to determine at least one of a transmit power or a timing advance for the group of compatible stations based on the metrics and resolutions.

13. The access point of claim 7, wherein the processor is further configured to determine a transmit power adjustment for the group of compatible stations based on the metrics and resolutions.

14. The access point of claim 7, wherein the processor is further configured to determine a frequency correction for the group of compatible stations based on the metrics and resolutions.

15. A method for associating an access point with a wireless area network having one or more wireless stations, comprising:
receiving, at the access point, within a single transmit opportunity, a respective metric and a respective resolution from each of a plurality of stations;
determining, at the access point, within the single transmit opportunity, a group of compatible stations based on the respective metrics and the respective resolutions; and
sending, from the access point, within the single transmit opportunity, a respective configuration to each station in the group of compatible stations based on the respective metrics and the respective resolutions for each station to transmit within the single transmit opportunity.

16. The method of claim 15, further comprising receiving, at the access point, within the single transmit opportunity, a respective transmission from each station in the group of compatible stations.

17. The method of claim 15, wherein the respective configuration comprises at least one of a respective power value or a respective frequency offset.

18. The method of claim 15, wherein the respective metric comprises one or more of a respective power value currently being used by the respective station or a respective frequency offset currently being used by the respective station.

19. The method of claim 15, wherein the respective resolution is associated with a type of uplink transmission from the respective station.

20. The method of claim 19, wherein the type of uplink transmission is one of a multiple input-multiple output (MU-MIMO) transmission frequency division based signaling protocol or an orthogonal frequency-division multiple access (OFDMA) transmission.
